(19) United States
(12) Patent Application Publication
(10) Pub. No.: US 2021/0252941 A1
(43) Pub. Date: Aug. 19, 2021

(54) VEHICLE AIR CONDITIONER

(71) Applicant: DENSO CORPORATION, Kariya-city (JP)

(72) Inventors: Terukazu HIGUCHI, Kariya-city (JP); Takamitsu KUSABA, Kariya-city (JP); Yuji AOKI, Kariya-city (JP); Hiroshi FUKUURA, Kariya-city (JP); Yasushi KONDO, Kariya-city (JP); Kotaro FUKUDA, Kariya-city (JP); Yoshinori KUMAMOTO, Kariya-city (JP)

(21) Appl. No.: 17/308,516

(22) Filed: May 5, 2021

Related U.S. Application Data
(63) Continuation of application No. PCT/JP2019/040580, filed on Oct. 16, 2019.

(30) Foreign Application Priority Data
Nov. 8, 2018 (JP) 2018-210307

(51) Int. Cl. B60H 1/00; B60H 1/32

(52) U.S. Cl. CPC B60H 1/00899; B60H 2001/00928; B60H 1/00278; B60H 1/32284

(57) ABSTRACT

An air conditioner applied to a hybrid vehicle includes a first heat medium circuit, a first heating heat exchanger, a first pump, a first hydraulic pump capacity controller, a second heat medium circuit, a second heating heat exchanger, a second pump, and a second hydraulic pump capacity controller. The first heat medium circuit and the second heat medium circuit are configured to be independent from each other to set a first air conditioning mode, a second air conditioning mode and a third air conditioning mode. When a temperature difference calculated by subtracting a first temperature of the first heat medium from a second temperature of the second heat medium is lower than or equal to a predetermined reference temperature difference during the third air conditioning mode, the first air conditioning mode is set by switching from the third air conditioning mode.

### CROSS REFERENCE TO RELATED APPLICATIONS

The present application is a continuation application of International Patent Application No. PCT/JP2019/040580 filed on Oct. 16, 2019, which designated the U.S. and claims the benefit of priority from Japanese Patent Application No. 2018-210307 filed on Nov. 8, 2018. The entire disclosures of all of the above applications are incorporated herein by reference.

### TECHNICAL FIELD

The present disclosure relates to an air conditioner for a vehicle configured to heat blown air.

### BACKGROUND

In a vehicle air conditioner for a hybrid vehicle, air to be blown into a vehicle interior is heated by switching a heat medium circuit according to an operating state of an engine.

### SUMMARY

An air conditioner for a hybrid vehicle in one exemplar according to the present disclosure is provided with a first heat medium circuit and a second heat medium circuit, which are configured to be independent from each other when a first air conditioning mode, a second air conditioning mode and a third air conditioning mode are switched.

### BRIEF DESCRIPTION OF DRAWINGS

The above and other objects, features and advantages of the present disclosure will become more apparent from the following detailed description made with reference to the accompanying drawings.

FIG. 1 is a diagram showing an overall configuration of a vehicle air conditioner according to an embodiment.

FIG. 2 is a block diagram showing an electric controller of the vehicle air conditioner according to the embodiment.

FIG. 3 is a time chart showing temperature changes of a first temperature and a second temperature according to the embodiment.

FIG. 4 is a flow chart showing a control processing of a refrigerant recovery preparation control according to the embodiment.

### DETAILED DESCRIPTION

A vehicle air conditioner for a hybrid vehicle is used to heat air to be blown into a vehicle interior that is a target space to be air-conditioned. Here, the hybrid vehicle is a vehicle which obtains driving force from an engine and a traveling electric motor in order to drive. The vehicle air conditioner heats the blown air by using coolant of the engine as a heat source so as to heat the vehicle interior.

More specifically, the vehicle air conditioner includes a heat medium circuit in which the coolant circulates between the engine and a heater core. The heater core is a heating heat exchanger that heats the blown air by exchanging heat between the coolant and the blown air. In addition, an electric heater is arranged in the heat medium circuit so as to heat the coolant at a time of stopping the engine or the like.

In the vehicle air conditioner, circuit structure of the heat medium circuit is switched according to an operating state of the engine. More specifically, when the engine is operated, the circuit structure is switched to a circuit of a normal heating operation in which the coolant after being heated by the engine and the electric heater flows into the heater core. On the other hand, when the engine is stopped, the circuit structure is switched to a circuit of a bypass heating operation in which the coolant after being heated by the electric heater and bypassing the engine flows into the heater core.

However, in this case, a temperature of the coolant which flows into the heater core may not be properly regulated, and comfortable air conditioning in the vehicle interior may be restricted.

For example, when the engine is operated, the temperature of the coolant heated by exhaust heat from the engine may be higher than a temperature of the coolant flowing into the heater core. In this state, the heat medium circuit is switched from the circuit of the bypass heating operation to the circuit of the normal heating operation. By switching the heat medium circuit as described above, the temperature of the coolant flowing into the heater core may rise suddenly. As a result, a temperature of the blown air supplied into the vehicle interior may rise more than necessary.

In addition, such as immediately after starting the engine, the temperature of the coolant heated by the exhaust heat from the engine may be lower than the temperature of the coolant flowing into the heater core. In this state, the heat medium circuit is switched from the circuit of the bypass heating operation to the circuit of the normal heating operation. By switching the heat medium circuit as described above, the temperature of the coolant flowing into the heater core falls. As a result, the temperature of the blown air supplied into the vehicle interior falls.

When the heat medium circuit is switched from the circuit of the bypass heating operation to the circuit of the normal heating operation, a circulation path of the cooling water becomes longer. Because of this, an amount of the coolant to be heated by the electric heater is increased. Therefore, even by increasing heating capacity of the electric heater, the temperature of the coolant flowing into the heater core is restricted from rising immediately. As a result, the temperature of the blown air supplied into the vehicle interior may be difficult to rise immediately.

It is an object of the present disclosure to provide an air conditioner used for a hybrid vehicle and configured to provide comfortable air conditioning in a vehicle interior.

An air conditioner in one exemplar according to the present disclosure is used for a hybrid vehicle which obtains a driving force to travel from an internal combustion engine and a traveling electric motor. The vehicle air conditioner includes a first heat medium circuit, a first heating heat exchanger, a first pump, a first hydraulic pump capacity controller, a second heat medium circuit, a second heating heat exchanger, a second pump, and a second hydraulic pump capacity controller.

A first medium heated by exhaust heat from the internal combustion engine circulates in the first heat medium circuit. The first heating heat exchanger is arranged in the first heat medium circuit and is configured to heat blown air by performing heat exchange between the first heat medium and the blown air supplied into the vehicle interior. The first pump is arranged in the first heat medium circuit and is configured to pressure-send the first heat medium toward the first heating heat exchanger. The first hydraulic pump capacity controller is configured to control operation of the first pump. A second medium heated by a heating part with an adjustable heating capacity circulates in the second heat medium circuit. The second heating heat exchanger is arranged in the second heat medium circuit and is configured to heat the blown air by performing the heat exchange between the second heat medium and the blown air. The second pump is arranged in the second heat medium circuit and is configured to pressure-send the second heat medium toward the second heating heat exchanger. The second hydraulic pump capacity controller is configured to control operation of the second pump. The first heat medium circuit and the second heat medium circuit are configured to be independent from each other to set a first air conditioning mode, a second air conditioning mode, and a third air conditioning mode.

In the first air conditioning mode, the first hydraulic pump capacity controller operates the first pump and the second hydraulic pump capacity controller stops the second pump, to supply the blown air heated by the first heating heat exchanger into the vehicle interior. In the second air conditioning mode, the second hydraulic pump capacity controller operates the second pump and the first hydraulic pump capacity controller stops the first pump, to supply the blown air heated by the second heating heat exchanger into the vehicle interior. In the third air conditioning mode, the first hydraulic pump capacity controller operates the first pump and the second hydraulic pump capacity controller operates the second pump, to supply the blown air heated by the first heating heat exchanger and the second heating heat exchanger into the vehicle interior.

According to the above air conditioner used for the vehicle, the first heat medium circuit and the second heat medium circuit are heat medium circuits configured to be independent from each other not to mix the first heat medium and the second heat medium with each other. Therefore, by switching one of the first to third air conditioning modes according to an operating state of the internal combustion engine, the comfortable air conditioning can be provided in the vehicle interior.

More specifically, the second air conditioning mode can be performed during a stop of the internal combustion engine. In the second air conditioning mode, the comfortable air conditioning can be provided in the vehicle interior as a temperature of the second heat medium is regulated properly by the heating part.

Further, when the internal combustion engine operates during performing the second air conditioning mode, the air conditioning mode can be switched to the third air conditioning mode. In the third air conditioning mode, the comfortable air conditioning can be provided in the vehicle interior as the temperature of the second heat medium is regulated properly by the heating part according to a temperature rise in the first heat medium.

Further, when a temperature of the first heat medium becomes a predetermined temperature during performing the third air conditioning mode, the air conditioning mode can be switched to the first air conditioning mode. In the first air conditioning mode, the comfortable air conditioning can be provided in the vehicle interior by using the first heat medium as a heat source.

When switching to any one of the air conditioning modes, the first heat medium and the second heat medium are not mixed with each other. Therefore, inappropriate temperature change is restricted. Therefore, the vehicle air conditioner is enabled to restrict the temperature change of the blown air supplied into the vehicle interior when applied to the hybrid vehicle, and the comfortable air conditioning in the vehicle interior can be provided.

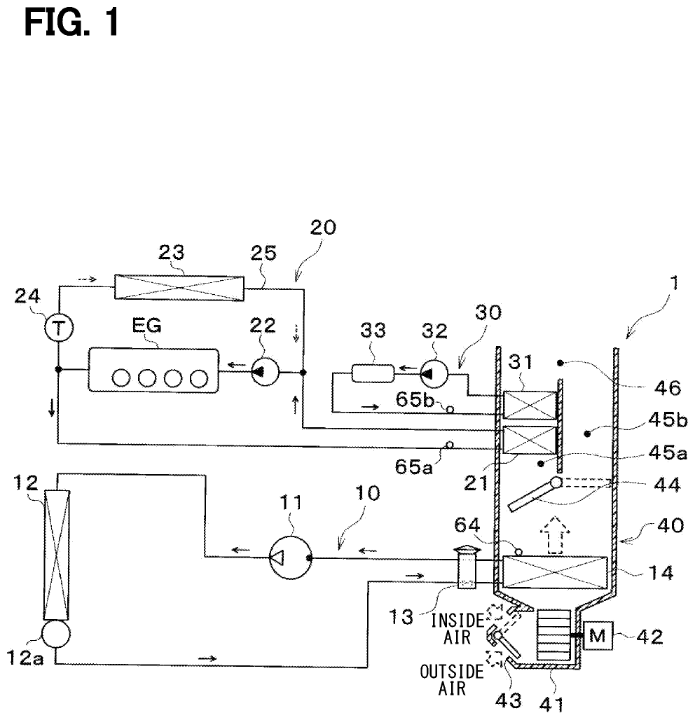

Next, a vehicle air conditioner 1 according to an embodiment in the present disclosure will be described in detail with reference to FIGS. 1 to 4. The vehicle air conditioner 1 in the present embodiment is applied to a hybrid vehicle which obtains a driving force from both of an engine EG (that is an internal combustion engine) and a traveling electric motor MG in order to drive. In addition, the hybrid vehicle is configured as a plug-in hybrid vehicle in which a battery 50 can be charged with electricity supplied from an external source (such as a commercial power source) during a stop of the vehicle.

In the plug-in hybrid vehicle, a traveling mode can be switched. More specifically, when a charge storage SOC of the battery 50 is higher than or equal to a predetermined storage KSOC, the vehicle is set in an EV traveling mode so as to travel mainly by the driving force of the traveling electric motor MG. On the other hand, the charge storage SOC is lower than the predetermined storage KSOC, the vehicle is set in a HV traveling mode so as to travel mainly by the driving force of the engine EG.

Even in the EV traveling mode, when a vehicle traveling load becomes high, the engine EG is operated so as to support the traveling electric motor MG. In addition, when the vehicle traveling load becomes high in the HV traveling mode, the traveling electric motor MG is operated so as to support the engine EG.

The plug-in hybrid vehicle switches between the EV traveling mode and the HV traveling mode as described above. Because of this, a vehicle fuel consumption can be enhanced compared with a normal vehicle which obtains the driving force in order to drive the vehicle only from the engine EG. A switch between the EV traveling mode and the HV traveling mode is controlled by a driving force controller 70.

The vehicle air conditioner 1 includes a refrigeration cycle device 10, a first heat medium circuit 20, a second heat medium circuit 30, an indoor air conditioning unit 40, and the like.

The refrigeration cycle device 10 is configured to cool blown air supplied into a vehicle interior in the vehicle air conditioner 1. FIG. 1 shows an overall configuration of the vehicle air conditioner 1. As shown in FIG. 1, the refrigeration cycle device 10 includes a compressor 11, a condenser 12, an expansion valve 13, and an evaporator 14 which are annularly connected through a refrigerant pipe.

In the refrigeration cycle device 10, a HFO-based refrigerant (such as R1234yf, more specifically) is used as a refrigerant. The refrigeration cycle device 10 provides a subcritical refrigeration cycle in a vapor compression type in which a pressure of a discharged refrigerant discharged from the compressor 11 does not exceed a critical pressure of the refrigerant. The refrigerant includes refrigerant oil in order to lubricate the compressor 11. Part of the refrigerant oil circulates in the refrigerant circuit with the refrigerant.

The compressor 11 is configured to suck, compress, and discharge the refrigerant in the refrigeration cycle device 10. The compressor 11 is arranged in a drive device chamber which also houses the internal combustion engine, the traveling electric motor, and the like. The drive device chamber is arranged close to a front of the vehicle interior. The compressor 11 is an electric compressor such that a rotation speed (that is, refrigerant discharge capacity) is controlled based on a control signal output from an air conditioning controller 60.

A refrigerant inlet port of the condenser 12 is connected to a discharge port of the compressor 11. The condenser 12 is a condensing heat exchanger configured to condense the refrigerant by heat exchange between the refrigerant discharged from the compressor 11 and outside air blown from an outdoor blower. The condenser 12 is arranged close to a front of the drive device chamber. Therefore, wind due to the movement of the vehicle can be supplied to the condenser 12 when the vehicle is traveling.

An inlet port of a receiver 12a is connected to a refrigerant outlet port of the condenser 12. The receiver 12a is a liquid storage part configured to separate gas and liquid. That is, the receiver 12a is configured to separate the gas and the liquid from the refrigerant which flows from the condenser 12. After that, part of liquid refrigerant separated from the refrigerant is stored as a surplus refrigerant in the cycle.

An inlet port of the expansion valve 13 is connected to a liquid refrigerant outlet port of the receiver 12a. The expansion valve 13 is a decompressor configured to decompress the refrigerant which flows from the receiver 12a.

The expansion valve 13 is a thermostatic expansion valve which includes a valve body and a temperature sensor. The valve body is configured to control a throttle opening degree. The temperature sensor is configured to displace the valve body. The temperature sensor includes a diaphragm which is a deformable member configured to be deformed corresponding to a temperature and a pressure in the refrigerant at an outlet port of the evaporator 14. A valve opening degree (that is the throttle opening degree) of the expansion valve 13 is controlled by transmitting the deformation of the diaphragm such that a superheat degree of the refrigerant at the outlet port of the evaporator 14 approaches a predetermined value.

A refrigerant inlet port of the evaporator 14 is connected to an outlet port of the expansion valve 13. The evaporator 14 is arranged in an air conditioning case 41 of the indoor air conditioning unit 40. The evaporator 14 is configured to evaporate a low-pressure refrigerant by the heat exchange between the low-pressure refrigerant decompressed by the expansion valve 13 and the blown air supplied into the vehicle interior. In addition, the evaporator 14 is an endothermic heat exchanger configured to cool the blown air by evaporating the low-pressure refrigerant and exerting effect of heat absorption. An intake port of the compressor 11 is connected to a refrigerant outlet port of the evaporator 14.

The first heat medium circuit 20 is a heat medium circulation circuit in which a first heat medium heated by exhaust heat from the engine EG circulates between a coolant passage of the engine EG and a first heater core 21. The first heat medium circuit 20 heats the blown air supplied into the vehicle interior, mainly in the HV traveling mode. As the first heat medium, a solution containing ethylene glycol, dimethylpolysiloxane, solution including a nanofluid or the like, an antifreeze solution, and the like can be employed.

At the first heat medium circuit 20, the coolant passage of the engine EG, the first heater core 21, a first pump 22, a radiator 23, and a thermostat 24 are arranged.

The first heater core 21 is arranged in the air conditioning case 41 of the indoor air conditioning unit 40. The first heater core 21 is a first heating heat exchanger configured to heat the blown air by the heat exchange between the first heat medium flowing from the coolant passage of the engine EG and the blown air.

An intake port of the first pump 22 is connected to a heat medium outlet port of the first heater core 21. The first pump 22 is a liquid pump configured to pressure-send the first heat medium flowing from the first heater core 21 toward the coolant passage of the engine EG. Therefore, by operating the first pump 22, the first heat medium circulates between the coolant passage of the engine EG and the first heater core 21.

An operation of the first pump 22 is controlled in accordance with a control voltage output from the driving force controller 70. When the engine EG is operated, such as in the HV traveling mode, the driving force controller 70 operates the first pump 22 so as to exert a predetermined effect of liquid pumping.

The first heat medium circuit 20 further includes a bypass passage 25 so as to guide the first heat medium flowing from the coolant passage of the engine EG to bypass the first heater core 21 and to flow to the intake port of the first pump 22. The radiator 23 is arranged on the bypass passage 25. That is, the radiator 23 and the first heater core 21 are connected in parallel to the first pump 22 and the coolant passage of the engine EG.

The radiator 23 is a radiational heat exchanger configured to cool the first heat medium by the heat exchange between the first heat medium discharged from the coolant passage of the engine EG and the outer air blown from an outdoor blower. The radiator 23 is arranged close to the front of the drive device chamber. Therefore, the wind due to the movement of the vehicle can be supplied to the radiator 23 when the vehicle is traveling.

The thermostat 24 is an on-off valve configured to open or close a heat medium inlet port of the radiator 23 corresponding to a temperature of the first heat medium flowing from the coolant passage of the engine EG. The thermostat 24 includes a mechanical mechanism in which a valve body is displaced by a thermowax changing its volume corresponding to a temperature change of the first heat medium.

In the present embodiment, the thermostat 24 opens the heat medium inlet port of the radiator 23 when the temperature of the first heat medium flowing from the coolant passage of the engine EG is higher than or equal to a predetermined reference temperature KTw. On the other hand, the heat medium inlet port of the radiator 23 is closed when the temperature of the first heat medium flowing from the coolant passage of the engine EG is lower than the reference temperature KTw.

Because of this, even when the engine EG is operated, the first heat medium does not flows into the radiator 23 to be cooled when the temperature of the first heat medium flowing from the coolant passage of the engine EG is lower than the reference temperature KTw. Therefore, the temperature of the first heat medium which circulates in the first heat medium circuit 20 rises so as to approach the reference temperature KTw.

Then, when the temperature of the first heat medium flowing from the coolant passage of the engine EG rises to the reference temperature KTw or higher, part of the first heat medium pumped from the first pump 22 flows into the radiator 23 to cool the first heat medium in the radiator 23. Therefore, the temperature of the first heat medium flowing from the coolant passage of the engine EG, that is the temperature of the first heat medium flowing into the first heater core 21, approaches the reference temperature KTw.

The second heat medium circuit 30 is a heat medium circulation circuit in which a second medium circulates between a water heater 33 and a second heater core 31. The second heat medium circuit 30 heats the blown air supplied into the vehicle interior, mainly in the EV traveling mode. As the second heat medium, fluid same as the first heat medium can be adopted.

In the second heat medium circuit 30, the second heater core 31, a second pump 32, and the water heater 33 are arranged.

The second heater core 31 is arranged in the air conditioning case 41 of the indoor air conditioning unit 40. The second heater core 31 is a second heating heat exchanger configured to heat the blown air by the heat exchange between the second heat medium heated by the water heater 33 and the blown air. A configuration of the second heater core 31 is basically similar to that of the first heater core 21.

An intake port of the second pump 32 is connected to a heat medium outlet port of the second heater core 31. The second pump 32 is a liquid pump configured to pressure-send the second heat medium flowing from the second heater core 31 toward an inlet port of the water heater 33. Therefore, by operating the second pump 32, the second heat medium circulates between the water heater 33 and the second heater core 31.

A configuration of the second pump 32 is basically similar to that of the first pump 22. An operation of the second pump 32 is controlled based on the control voltage output from the air conditioning controller 60.

The water heater 33 is a heating part which includes an electric heater configured to heat the second heat medium by generating the heat by power supply. Heating capacity of the water heater 33 is controlled according to the control voltage output from the air conditioning controller 60.

As described above, the first heat medium circuit 20 and the second heat medium circuit 30 are heat medium circuits configured to be formed independent from each other so as not to mix the first heat medium and the second heat medium.

Next, the indoor air conditioning unit 40 will be described below. The indoor air conditioning unit 40 is configured to supply the blown air, which has been controlled at a predetermined temperature suitable to perform the air conditioning in the vehicle interior, toward a proper position in the vehicle interior. The indoor air conditioning unit 40 is arranged inside an instrument panel at the front of the vehicle interior.

As shown in FIG. 1, the indoor air conditioning unit 40 houses an indoor blower 42, the evaporator 14, the first heater core 21, the second heater core 31, and the like in the air conditioning case 41. The air conditioning case 41 forms an air passage of the blown air. The air conditioning case 41 is formed of resin (for example, polypropylene) which has a certain degree of elasticity and high strength.

An inside-outside air switching device 43 is arranged close to most upstream of the air conditioning case 41 in a blown air flow. The inside-outside air switching device 43 switches and introduces inside air (air in the vehicle interior) and outside air (air outside the vehicle interior) into the air conditioning case 41. Operation of an electric actuator to drive the inside-outside air switching device 43 is controlled based on a control signal output from the air conditioning controller 60.

The indoor blower 42 is arranged downstream of the inside-outside air switching device 43 in the blown air flow. The indoor blower 42 is configured to blow the air sucked through the inside-outside air switching device 43 into the vehicle interior. The indoor blower 42 is an electric blower in which a centrifugal multi-blade is driven by an electric motor. A rotation speed (that is blowing capacity) of the indoor blower 42 is controlled based on the control voltage output from the air conditioning controller 60.

The evaporator 14, the first heater core 21, and the second heater core 31 are arranged in this order downstream of the indoor blower 42 in the blown air flow. That is, the evaporator 14 is arranged upstream of the first heater core 21 in the blown air flow. The first heater core 21 is arranged upstream of the second heater core 31 in the blown air flow. In other words, the second heater core 31 is arranged in an air passage formed in the air conditioning case 41 so as to heat the blown air after passing through the first heater core 21.

A cool air bypass passage 45a is provided in the air conditioning case 41 such that the blown air after passing through the evaporator 14 bypasses the first heater core 21 and the second heater core 31. The first heater core 21 and the second heater core 31 are arranged in a heating passage 45b. An air-mix door 44 is arranged downstream of the evaporator 14 in the blown air flow and upstream of the first heater core 21 and the second heater core 31 in the blow air flow in the air conditioning case 41.

The air-mix door 44 is an air volume ratio adjusting unit configured to adjust an air volume ratio between an air volume of the blown air passing through the cool air bypass passage 45a and an air volume of the blown air passing through the heating passage 45b in the blown air after passing the evaporator 14. Operation of an electric actuator to drive the air-mix door 44 is controlled based on a control signal output from the air conditioning controller 60.

A mixing space 46 is formed downstream of the cool air bypass passage 45a and the heating passage 45b in the blown air flow in the air conditioning case 41. The mixing space 46 is a space so as to mix the blown air heated by passing through the heating passage 45b and the blown air which is not heated by passing through the cool air bypass passage 45a.

In addition, opening holes are provided downstream of the air conditioning case 41 in the blown air flow. The blown air is supplied to the vehicle interior through the opening hole after its temperature is controlled by mixing in the mixing space 46.

The opening holes include a face opening hole, a foot opening hole, and a defroster opening hole (any of them is not shown in the drawings). The face opening hole is an opening hole through which conditioned air blows toward an upper body of an occupant in the vehicle interior. The foot opening hole is an opening hole through which the conditioned air blows toward feet of the occupant. The defroster opening hole is an opening hole through which the conditioned air blows toward an inner surface of a vehicle front window grass.

The air-mix door 44 is configured to adjust the air volume ratio between the air volume of the blown air passing through the cool air bypass passage 45a and the air volume of the blown air passing through the heating passage 45b. Thereby, a temperature of the conditioned air mixed in the mixing space 46 is adjusted. As a result, the temperature of the blown air (conditioned air) blown from each of outlet ports into the vehicle interior is adjusted.

A face door, a foot door, and a defroster door (none of which are shown in the drawings) are provided upstream of the blown air flow with respect to the face opening hole, the foot opening hole, and the defroster opening hole, respectively. The face door, the foot door, and the defroster door are opening/closing portions configured to open or close the corresponding opening holes.

The doors are connected to a common electric actuator to drive the doors through a link mechanism or the like and are operated to rotate in conjunction with the actuator. Operation of the electric actuator to drive the doors is controlled based on the control signal output from the air conditioning controller 60.

An outline of an electric controller in the present embodiment will be described below. The air conditioning controller 60 includes a known microcomputer including a CPU, a ROM, a RAM, and the like, and a peripheral circuit of the microcomputer. The air conditioning controller 60 is configured to perform various calculations and processes based on an air conditioning control program stored in the ROM. In addition, the air conditioning controller 60 is configured to control operation of various control target devices 11, 32, 33, 42 and the like which are connected to an output of the air conditioning controller 60.

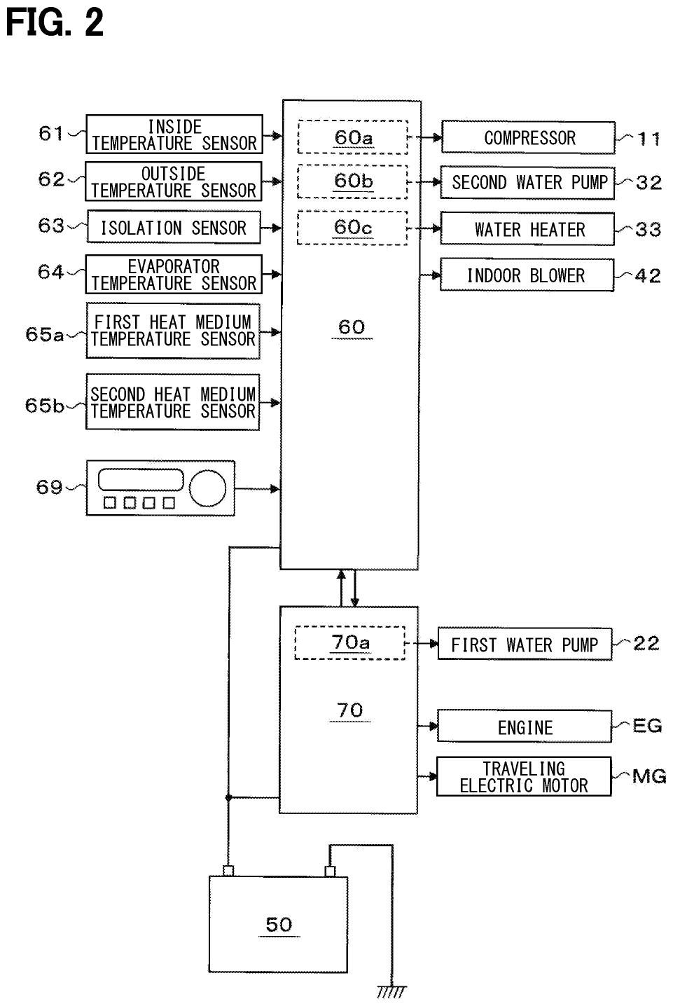

As shown in a block diagram in FIG. 2, an input of the air conditioning controller 60 is connected with an inside temperature sensor 61, an outside temperature sensor 62, an isolation sensor 63, an evaporator temperature sensor 64, a first heat medium temperature sensor 65a, a second heat medium temperature sensor 65b, and the like. Detection signals of the above sensors to control the air condition are input to the air conditioning controller 60.

The inside temperature sensor 61 is an inside temperature detector configured to detect a temperature in the vehicle interior (inside air temperature) Tr. The outside temperature sensor 62 is an outside temperature detector configured to detect a temperature outside the vehicle interior (outside air temperature) Tam. The isolation sensor 63 is an isolation amount detector configured to detect an isolation amount Ts radiated into the vehicle interior.

The evaporator temperature sensor 64 is an evaporator temperature detector configured to detect a refrigerant evaporation temperature (evaporator temperature) Tefin in the evaporator 14. More specifically, the evaporator temperature sensor 64 detects a temperature of a heat exchange fin of the evaporator 14.

The first heat medium temperature sensor 65a is a first heat medium temperature detector configured to detect a first temperature Tw1 of the first heat medium which flows into the first heater core 21. The second heat medium temperature sensor 65b is a second heat medium temperature detector configured to detect a second temperature Tw2 of the second heat medium which flows into the second heater core 31.

As shown in FIG. 2, the input of the air conditioning controller 60 is connected with an operation panel 69 arranged around an instrument panel close to the front of the vehicle interior. Operation signals from various operation switches provided on the operation panel 69 are input to the air conditioning controller 60.

The operation panel 69 includes the various operation switches such as an auto switch, an air conditioner switch, an air volume setting switch, a temperature setting switch, an outlet mode switching switch, and the like. The auto switch is an air conditioning operation setting unit so as to set or cancel an automatic control operation of the vehicle air conditioner 1. The air conditioner switch is a cool request unit so as to request that the evaporator 14 cools the blown air. The air volume setting switch is an air volume setting unit so as to manually set an air volume of the indoor blower 42. The temperature setting switch is a temperature setting unit so as to set a predetermined temperature Tset in the vehicle interior. The outlet mode switching switch is an outlet mode setting unit so as to manually set an outlet mode.

The air conditioning controller 60 is integrally constituted by controllers configured to control the various control target devices connected to the output of the air conditioning controller 60. Therefore, configurations (hardware and software) to control the operations of the control target devices correspond to the controllers to control the operations of the control target devices, respectively.

For example, a discharge capacity controller 60a in the air conditioning controller 60 is configured to control operation of the compressor 11. A second hydraulic pump capacity controller 60b is configured to control operation of the second pump 32. A heating capacity controller 60c is configured to control operation of the water heater 33.

The air conditioning controller 60 is electrically connected with the driving force controller 70. The air conditioning controller 60 and the driving force controller 70 are communicably connected with each other. Therefore, the air conditioning controller 60 is enabled to detect whether the traveling mode of the vehicle at the point is the EV traveling mode or the HV traveling mode according to a transmission signal transmitted from the driving force controller 70.

A configuration of the driving force controller 70 is basically similar to that of the air conditioning controller 60. In the driving force controller 70, a first hydraulic pump capacity controller 70a is configured to control operation of the first pump 22. The air conditioning controller 60 and the driving force controller 70 may be formed integrally as a single controller.

The operation of the vehicle air conditioner 1 in the above configuration according to the present embodiment will be described below. The vehicle air conditioner 1 performs the air conditioning control program preliminarily stored in the air conditioning controller 60, as the auto switch of the operation panel 69 is turned on.

In the air conditioning control program, detection signals of the sensors to control the air condition and an operation signal of the operation panel 69 are read. Then, a target outlet temperature TAO of the blown air supplied into the vehicle interior is calculated based on the read detection signal and operation signal.

More specifically, the target outlet temperature TAO is calculated by the following formula F1.

TAO=Kset×Tset−Kr×Tr−Kam×Tam−Ks×As+C (F1)

Here, Tset is the predetermined temperature in the vehicle interior set by the temperature setting switch. Tr is the inside air temperature detected by the inside temperature sensor 61. Tam is the outside air temperature detected by the outside temperature sensor 62. Ts is the isolation amount detected by the isolation sensor 63. Kset, Kr, Kam, and Ks are control gains. C is a constant for control.

In the air conditioning control program, the control signals output to the various control target devices connected to the output of the air conditioning controller 60 are appropriately set based on the target outlet temperature TAO or the like. Because of this, the temperature of the blown air supplied toward the vehicle interior approaches the target outlet temperature TAO.

For example, the control signal output to the compressor 11 is set such that the evaporator temperature Tefin detected by the evaporator temperature sensor 64 approaches a target evaporator temperature TEO. The target evaporator temperature TEO is set based on the target outlet temperature TAO with reference to a control map preliminarily stored in the air conditioning controller 60. In the control map, the target evaporator temperature TEO rises as the target outlet temperature TAO rises.

The control voltage output to the indoor blower 42 is set based on the target outlet temperature TAO with reference to the control map preliminarily stored in the air conditioning controller 60. In the control map, volume of the air blown by the indoor blower 42 is maximized in an extremely low temperature range (that is maximum cool range) in the target outlet temperature TAO and in an extremely high temperature range (that is maximum heat range) in the target outlet temperature TAO. In addition, the volume of the air blown by the indoor blower 42 is decreased as the target outlet temperature TAO approaches an intermediate temperature range.

Further, the control signal output to the electric actuator to drive the air-mix door 44 is set such that an opening degree of the air-mix door 44 approaches a target opening degree SW.

More specifically, the target opening degree SW is calculated by the following formulas F2 and F3.

SW={(TAO−Tefin)/(Tw−Tefin)}×100(%) (F2)

Tw=max{Tw1,Tw2} (F3)

Here, Tw1 is the first temperature of the first heat medium detected by the first heat medium temperature sensor 65a. Tw2 is the second temperature of the second heat medium detected by the second heat medium temperature sensor 65b. In the formula F3, a higher value in Tw1 and Tw2 is adopted as Tw.

SW=100% in the formula F2 corresponds to a maximum heating opening degree. At the maximum heating opening degree, the control signal is set so as to position the air-mix door 44 such that the cool air bypass passage 45a is fully closed and the heating passage 45b is fully opened. SW=0% in the formula F2 corresponds to a maximum cooling opening degree. At the maximum cooling opening degree, the control signal is set so as to position the air-mix door 44 such that the cool air bypass passage 45a is fully opened and the heating passage 45b is fully closed.

The control signal output to the second pump 32 is set so as to produce the predetermined effect of the liquid pumping based on the transmission signal received from the driving force controller 70, at least when the traveling mode is the EV traveling mode.

The control voltage output to the water heater 33 is set such that the second temperature Tw2 approaches the reference temperature KTw by using a feedback control method, at least when the traveling mode is the EV traveling mode.

Further, in the air conditioning control program, the control signals detected as described above or the like are output to the various control target devices. After that, in the air conditioning control program, a control routine is repeated at each time of a predetermined control circle until a stop of the vehicle air conditioner is requested. The control routine includes read of the detection signal and the control signal, determination of the control signal output to the various control target devices and the like, and output of the control signal and the like, in this order.

Therefore, in the refrigeration cycle device 10, the high-temperature and high-pressure refrigerant discharged from the compressor 11 flows into the condenser 12. The refrigerant which flows into the condenser 12 is condensed by the heat exchange with the outside air which flows from the outdoor blower. The refrigerant which flows from the condenser 12 is separated into the gas and the liquid at the receiver 12a. The liquid refrigerant separated in the receiver 12a is decompressed by the expansion valve 13.

The low-pressure refrigerant decompressed by the expansion valve 13 flows into the evaporator 14. The refrigerant which flows into the evaporator 14 is evaporated by the heat exchange with the blown air blown from the indoor blower 42. As a result, the blown air is cooled. The refrigerant which flows from the evaporator 14 is drawn into the compressor 11 and is compressed again.

In the indoor air condition unit 40, the blown air cooled by the evaporator 14 is distributed to the cool air bypass passage 45a and the heating passage 45b corresponding to the opening degree of the air-mix door 44. The blown air which flows into the heating passage 45b passes through the first heater core 21 and the second heater core 31 in this order and is heated.

The blown air heated by passing through the heating passage 45b is mixed with the blown air which had passed through the cool air bypass passage 45a in the mixing space 46. As a result, the temperature of the blown air mixed in the mixing space 46 approaches the target outlet temperature TAO. The blown air at the suitable temperature adjusted in the mixing space 46 is blown toward the proper position in the vehicle interior though an opening outlet port.

As a result, when the inside air temperature Tr is maintained lower than the outside air temperature Tam, cooling in the vehicle interior is performed. On the other hand, when the inside air temperature Tr is maintained higher than the outside air temperature Tam, heating in the vehicle interior is performed.

Further, the vehicle air conditioner 1 in the present embodiment is configured to be switched in three air conditioning modes including a first to third air conditioning modes according to the traveling mode.

The first air conditioning mode is a mode in which the first pump 22 is operated while the second pump 32 is stopped so as to blow the air heated by the first heater core 21 to the vehicle interior.

The second air conditioning mode is a mode in which the second pump 32 is operated and while the first pump 22 is stopped so as to blow the air heated by the second heater core 31 to the vehicle interior.

The third air conditioning mode is a mode in which the first pump 22 and the second pump 32 are operated so as to blow the air heated by the first heater core 21 and the second heater core 31 to the vehicle interior.

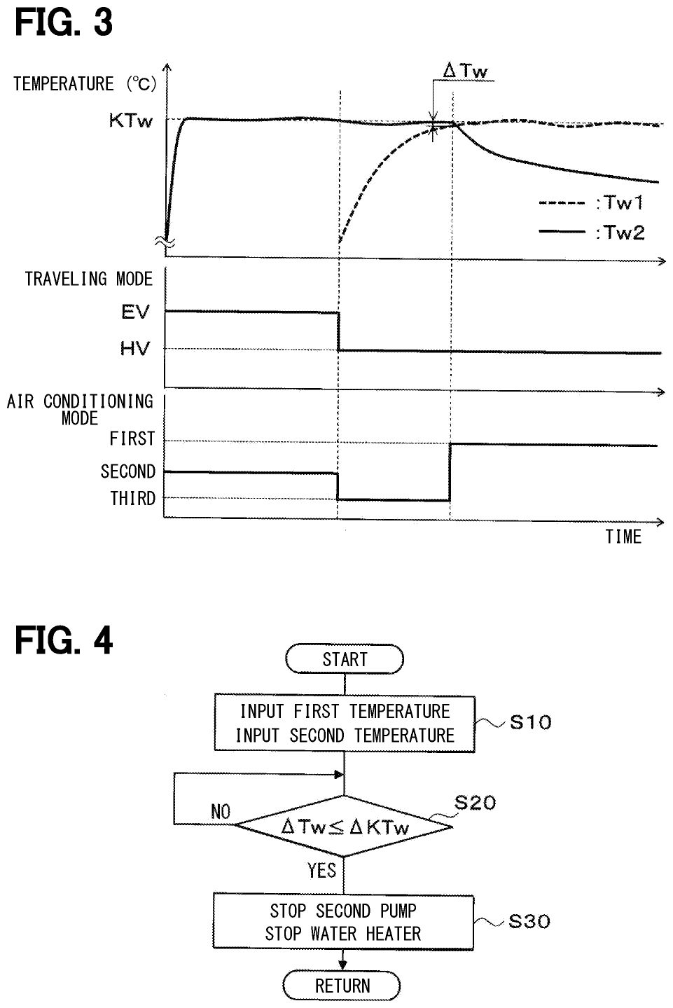

Switching in the above air conditioning modes will be described with reference to FIGS. 3 and 4. As described above, when the charge storage SOC of the battery 50 is higher than or equal to the predetermined storage KSOC, the driving force controller 70 switches the traveling mode to the EV traveling mode.

In the EV traveling mode, the driving force controller 70 stops the first pump 22. Further, the air conditioning controller 60 operates the second pump 32 and supplies the electricity to the water heater 33. Therefore, the second heat medium is heated by the water heater 33 in the EV traveling mode.

Therefore, as shown by a thick solid line in FIG. 3, the temperature Tw2 of the second heat medium flowing into the second heater core 31 rises so as to approach the reference temperature KTw. On the other hand, the temperature Tw1 of the first heat medium flowing into the first heater core 21 does not rise as the engine EG is stopped. Because of this, the air conditioning in the second air conditioning mode is performed in the EV traveling mode. In other words, the second air conditioning mode is performed when the engine EG is stopped.

After that, when the charge storage SOC is decreased and becomes lower than the predetermined storage KSOC, the driving force controller 70 switches the traveling mode to the HV traveling mode. The engine EG is operated in the HV traveling mode. Further, the driving force controller 70 operates the first pump 22 in the HV traveling mode. Therefore, in the HV traveling mode, the first heat medium is heated by the exhaust heat of the engine EG when passing through the coolant passage of the engine EG.

As shown by a thick broken line in FIG. 3, the temperature Tw1 of the first heat medium flowing into the first heater core 21 rises so as to approach the reference temperature KTw. Further, the air conditioning controller 60 performs a control flow shown in FIG. 4 when the traveling mode is switched from the EV traveling mode to the HV traveling mode. The control flow shown in FIG. 4 is performed as a subroutine for a main routine of the air conditioning control program.

At step S10 in the control flow shown in FIG. 4, the temperature Tw1 of the first heat medium and the temperature Tw2 of the second heat medium are read. After that, at step S20, it is determined whether or not a temperature difference ΔTw (Tw2−Tw1) calculated by subtracting the temperature Tw1 from the temperature Tw2 is lower than or equal to a predetermined reference temperature difference ΔKTw (3° C. in the present embodiment). At step S20, when the temperature difference ΔTw is determined as lower than or equal to the reference temperature difference ΔKTw, the control flow proceeds to step S30.

On the other hand, when the temperature difference ΔTw is determined as larger than the reference temperature difference ΔKTw at step S20, the control flow returns to step S10 after passing a predetermined control circle. That is, when the control flow returns to step S10, the air conditioning is performed in the third air conditioning mode. In other words, the third air conditioning mode is performed when the engine EG is operated while the second air conditioning mode is performed.

At step S30, the second pump 32 and the power supply to the water heater 33 are stopped, and the air conditioning control program returns to the main routine from the sub routine. Because of this, the air conditioning is performed in the first air conditioning mode. In other words, the first air conditioning mode is the air conditioning mode performed when the temperature difference ΔTw becomes lower than or equal to the reference temperature difference ΔKTw during performing the third air conditioning mode.

Then, in the first air conditioning mode, as shown in FIG. 3, the temperature Tw1 of the first heat medium flowing into the first heater core 21 is maintained at the reference temperature KTw by the exhaust heat of the engine EG. On the other hand, as the power supply to the water heater 33 is stopped, the temperature Tw2 of the second heat medium which flows into the second heater core 31 falls.

As described above, in the vehicle air conditioner 1 according to the present embodiment, the air conditioning mode can be switched in the three air conditioning modes including the first to three modes. The heat medium circuits are configured to be independent from each other so as not to mix the first heat medium and the second heat medium, therefore, the air condition in the vehicle interior can be comfortable.

More specifically, in the EV traveling mode in which the engine EG is stopped, the second air conditioning mode can be performed. In the second air conditioning mode, by controlling the heating capacity of the water heater 33, the temperature of the second heat medium which flows into the second heater core 31 can be adjusted at the suitable temperature to perform the air conditioning in the vehicle interior.

Therefore, even when the vehicle drives under an operating condition in which the first heat medium flowing into the first heater core 21 can not be heated by the exhaust heat of the engine EG, the air condition in the vehicle interior can be comfortable by heating the blown air at the second heater core 31 to the suitable temperature.

When the engine EG is operated during performing the second air conditioning mode by switching the traveling mode from the EV traveling mode to the HV traveling mode, the air conditioning mode can be switched to the third air conditioning mode. In the third air conditioning mode, the water heater 33 enables the temperature of the second heat medium to adjust at the temperature suitable to perform the air conditioning in the vehicle interior, corresponding to a temperature rise of the first heat medium.

Therefore, the air condition in the vehicle interior can be comfortable as the blown air is heated to the suitable temperature at the first heater core 21 and the second heater core 31. That is, even when the temperature of the first heat medium which flows into the first heater core 21 dose not rise sufficiently, the second heater core 31 enables to heat the blown air to the suitable temperature. As a result, even when the air conditioning mode is switched, the air condition in the vehicle interior can be comfortable without temperature change in the blown air.

When the temperature of the first heat medium rises to the temperature suitable to perform the air condition in the vehicle interior during performing the third air conditioning mode, the air conditioning mode can be switched to the first air conditioning mode. In the first air conditioning mode, the first heater core 21 heats the blown air to the suitable temperature, and the air condition in the vehicle interior can be comfortable.

That is, when switching to any one of the air conditioning modes, the first heat medium and the second heat medium are not mixed with each other. Therefore, inappropriate temperature change is restricted. Therefore, when the vehicle air conditioner 1 in the present embodiment is applied to the hybrid vehicle, the temperature change of the blown air supplied into the vehicle interior can be restricted, and the air condition in the vehicle interior can be comfortable.

Further, the vehicle air conditioner 1 according to the present embodiment can be switched to the third air conditioning mode. Accordingly, in order to raise the temperature of the first heat medium, the air conditioning controller 60 is not required to output a request signal to increase the output of the engine EG toward the driving force controller 70. Therefore, a vehicle fuel consumption can be restricted from deterioration.

In addition, as shown by step S20 in FIG. 4, when the temperature difference ΔTw becomes lower than or equal to the reference temperature difference ΔKTw, the vehicle air conditioner 1 according to the present embodiment is shifted to the first air conditioning mode. As a result, the vehicle air conditioner 1 can be shifted from the third air conditioning mode to the first air conditioning mode without causing a sudden change in the temperature of the blown air supplied into the vehicle interior.

Further, in the vehicle air conditioner 1 according to the present embodiment, the second heater core 31 is located so as to heat the blown air after passing through the first heater core 21. That is, the second heater core 31 is arranged downstream in the blown air flow and is configured to heat the blown air by using the second heat medium as a heat source. The temperature of the second heat medium can be controlled more easily than that of the first heat medium. Therefore, the blown air can be heated to the suitable temperature, furthermore.

In the first air conditioning mode, the second temperature Tw2 may be lower than the first temperature Tw1. However, the second pump 32 is stopped in the first air conditioning mode. Further, the blown air passes through the second heater core 31 after being heated enough by the first heater core 21. Because of this, a temperature fall in the second heat medium stored in the second heater core 31 is small.

Therefore, although the second heater core 31 is arranged to be able to heat the blown air after passing through the first heater core 21, a negative influence on the temperature control of the blown air in the third air conditioning mode is small.

When the first temperature Tw1 of the first heat medium approaches the reference temperature KTw by starting the engine EG in the first air conditioning mode, the vehicle air conditioner may be shifted to the third air conditioning mode. Further, while using the temperature of the first heat medium and the temperature of the second heat medium, the air conditioning mode may be shifted to the second air conditioning mode. As a result, the heat in the first heat medium and the second heat medium can be used effectively when the air conditioning mode changes.

The present disclosure is not limited to the embodiments described above, and various modifications can be made as follows within a scope not departing from the spirit of the present disclosure.

The above embodiment describes an example in which the vehicle air conditioner 1 of the present disclosure is applied to the plug-in hybrid vehicle. However, the application of the vehicle air conditioner 1 is not limited thereto. For example, corresponding to the vehicle traveling load, the vehicle air conditioner 1 may be applied to a normal hybrid vehicle in which a driving force ratio of the driving force output from the engine EG to the driving force output from the traveling electric motor MG is controlled.

Further, the vehicle air conditioner 1 may be applied to a normal vehicle which obtains the driving force only from the engine EG. In this case, as the first temperature Tw1 is always higher than the second temperature Tw2, the air conditioning in the vehicle interior can be performed in the first air conditioning mode. Similarly, the vehicle air conditioner 1 may be applied to an electric vehicle which obtains the driving force only from the traveling electric motor MG. In this case, as the second temperature Tw2 is always higher than the first temperature Tw1, the air conditioning in the vehicle interior can be performed in the second air conditioning mode.

That is, the vehicle air conditioner 1 in the present disclosure is not limited to the plug-in hybrid vehicle and can be applied to a wide variety of vehicle types. As a result, a common specification can be designed (that is series design) to the wide variety of the vehicle types.

Each configuration of the vehicle air conditioner 1 is not limited to that disclosed in the above embodiments.

For example, the above embodiments describes an example in which the electric compressor is employed as the compressor 11 of the refrigeration cycle device 10. However, an engine-driven type compressor may be employed as the compressor 11. Further, a variable capacity type compressor configured to adjust the refrigerant discharge capacity by changing discharge capacity may be employed as the engine-driven type compressor.

Further, the above embodiments describes an example in which the thermostatic expansion valve is employed as the expansion valve 13 of the refrigeration cycle device 10. However, an electric expansion valve may be employed as the expansion valve 13. The electric expansion valve is an electrical type variable throttle mechanism and includes a valve body and an electric actuator. The valve body is configured to change a throttle opening degree. The electric actuator is configured to change an opening degree of the valve body. Operation of the electric expansion valve may be controlled based on the control signal output from the air conditioning controller 60.

In addition, in the embodiments described above, although the R1234yf is employed as the refrigerant, the refrigerant is not limited thereto. For example, R134a, R600a, R410A, R404A, R32, R407C, and the like may be employed. Alternatively, a mixed refrigerant or the like in which multiple types of the above refrigerants are mixed together may be employed.

Further, in the above embodiments, although the refrigeration cycle device 10 is employed, the refrigeration cycle device 10 may be eliminated when the vehicle air conditioner 1 is used as a heater dedicated to heat.

Further, in the above embodiments, although the water heater 33 is employed as the heating part in the second heat medium circuit 30, a heat pump cycle may be employed as the heating part. For example, the refrigeration cycle device 10 described in the above embodiments may include a coolant-refrigerant heat exchanger configured to heat the second heat medium by the heat exchange between the second heat medium and the discharged refrigerant discharged from the compressor 11.

Further, although detailed configurations of the condenser 12 and the radiator 23 are not described in the above embodiments, the condenser 12 and the radiator 23 may be formed integral with each other. The outside air blown from a common outer air blower may be blown to both the condenser 12 and the radiator 23.

The above embodiments describes an example in which the air conditioning mode is switched from the third air conditioning mode to the first air conditioning mode when the temperature difference ΔTw becomes lower than or equal to the reference temperature difference ΔKTw, as shown by step S20 in FIG. 4. However, the switching of the air conditioning mode is not limited thereto. For example, when a value calculated by subtracting the second temperature Tw2 from the reference temperature KTw is lower than or equal to the reference temperature difference ΔKTw, the air conditioning mode may be switched from the third air conditioning mode to the first air conditioning mode.

Although the present disclosure has been described in accordance with the examples, it is understood that the present disclosure is not limited to such examples or structures. The present disclosure is intended to cover various modification examples and equivalents thereof. In addition, while the various elements are shown in various combinations and configurations, which are exemplary, other combinations and configurations, including more, less or only a single element, are also within the spirit and scope of the present disclosure.

What is claimed is:

1. An air conditioner for a hybrid vehicle which obtains a driving force to travel from an internal combustion engine and a traveling electric motor, the air conditioner comprising:
a first heat medium circuit in which a first heat medium heated by exhaust heat from the internal combustion engine circulates;
a first heating heat exchanger arranged in the first heat medium circuit and configured to heat blown air by performing heat exchange between the first heat medium and the blown air to be supplied into the vehicle interior;
a first pump arranged in the first heat medium circuit and configured to pressure-send the first heat medium toward the first heating heat exchanger;
a first hydraulic pump capacity controller configured to control operation of the first pump;
a second heat medium circuit in which a second heat medium heated by a heating part with an adjustable heating capacity circulates;
a second heating heat exchanger arranged in the second heat medium circuit and configured to heat the blown air by performing the heat exchange between the second heat medium and the blown air;
a second pump arranged in the second heat medium circuit and configured to pressure-send the second heat medium toward the second heating heat exchanger; and
a second hydraulic pump capacity controller configured to control operation of the second pump, wherein
the first heat medium circuit and the second heat medium circuit are configured to be independent from each other to set a first air conditioning mode, a second air conditioning mode and a third air conditioning mode,
in the first air conditioning mode, the first hydraulic pump capacity controller operates the first pump and the second hydraulic pump capacity controller stops the second pump, to supply the blown air heated by the first heating heat exchanger into the vehicle interior,
in the second air conditioning mode, the second hydraulic pump capacity controller operates the second pump and the first hydraulic pump capacity controller stops the first pump, to supply the blown air heated by the second heating heat exchanger into the vehicle interior,
in the third air conditioning mode, the first hydraulic pump capacity controller operates the first pump and the second hydraulic pump capacity controller operates the second pump, to supply the blown air heated by the first heating heat exchanger and the second heating heat exchanger into the vehicle interior, and
the first air conditioning mode is switched from the third air conditioning mode when a temperature difference calculated by subtracting a first temperature from a second temperature is lower than or equal to a predetermined reference temperature difference during the third air conditioning mode, in which the first temperature is a temperature of the first heat medium flowing into the first heating heat exchanger and the second temperature is a temperature of the second heat medium flowing into the second heating heat exchanger.

2. The air conditioner for a hybrid vehicle according to claim 1, wherein
the second air conditioning mode is set when the internal combustion engine is stopped.

3. The air conditioner for a hybrid vehicle according to claim 1, wherein
the third air conditioning mode is switched from the second air conditioning mode when the internal combustion engine is operated in the second air conditioning mode.

4. The air conditioner for a hybrid vehicle according to claim 1, wherein
the second heating heat exchanger is arranged to heat the blown air after passing through the first heating heat exchanger.

5. An air conditioner for a hybrid vehicle which obtains a driving force to travel from an internal combustion engine and a traveling electric motor, the vehicle air conditioner comprising:
a first heat medium circuit in which a first heat medium heated by exhaust heat from the internal combustion engine circulates;
a first heating heat exchanger arranged in the first heat medium circuit and configured to heat blown air by using the first heat medium having a first temperature and flowing into the first heating heat exchanger;
a first pump arranged in the first heat medium circuit and configured to pressure-send the first heat medium toward the first heating heat exchanger;
a second heat medium circuit in which a second heat medium heated by a heating part with an adjustable heating capacity circulates, the second heat medium circuit being separated from the first heat medium circuit;
a second heating heat exchanger arranged in the second heat medium circuit and configured to heat the blown air by using the second heat medium having a second temperature and flowing into the second heating heat exchanger;
a second pump arranged in the second heat medium circuit and configured to pressure-send the second heat medium toward the second heating heat exchanger; and
a controller configured to set a first air conditioning mode in which the controller operates the first pump and stops the second pump to heat the blown air by heat exchange with the first heat medium, a second air conditioning mode in which the controller operates the second pump and stops the first pump to heat the blown air by heat exchange with the second heat medium, and a third air conditioning mode in which the controller operates both the first pump and the second pump to supply the blown air heated by the first heating heat exchanger and the second heating heat exchanger into the vehicle interior, wherein
the controller is configured to switch the first air conditioning mode from the third air conditioning mode in response to a temperature difference between the second temperature and the first temperature during the third air conditioning mode.
